(19) United States
(12) Patent Application Publication
(10) Pub. No.: US 2008/0214214 A1
(43) Pub. Date: Sep. 4, 2008

(54) Method and System for Telecommunication with the Aid of Virtual Control Representatives

(75) Inventors: Christian Reissmueller, Sulzberg (DE); Frank Schueler, karlsruhe (DE); Markus Knaup, Karlsruhe (DE); Pierre-Alain Cotte, Amberg (DE); Michael Greve, Karlsruhe (DE); Matthias Greve, Karlsruhe (DE)

Correspondence Address: DARBY & DARBY P.C., P.O. BOX 770, Church Street Station, New York, NY, 10008-0770, US

(73) Assignee: comBOTS Product GmbH & Co., KG, KARLSRUHE (DE)

(21) Appl. No.: 10/597,557

(22) PCT Filed: Jan. 31, 2005
(86) PCT No.: PCT/EP2005/000939

§ 371 Date: Apr. 7, 2008

Related U.S. Application Data
(60) Provisional application No. 60/574,489, filed on May 26, 2004.
(60) Provisional application No. 60/584,698, filed on Jul. 1, 2004.
(60) Provisional application No. 60/586,469, filed on Jul. 8, 2004.
(60) Provisional application No. 60/638,556, filed on Dec. 23, 2004.

(30) Foreign Application Priority Data
Jan. 30, 2004 (EP) 04002154.5
May 21, 2004 (EP) 04012120.4
Jul. 8, 2004 (DE) 10 2004 033 164.2
Dec. 22, 2004 (DE) 10 2004 061884.4

(51) Int. Cl. H04Q 7/20

(52) U.S. Cl. 455/466

(57) ABSTRACT

Method and system of telecommunication between at least two users over a telecommunications network, wherein the first user is connected to the telecommunications network via a first terminal and the second user via a second terminal, and wherein a virtual representative is allocated to each user. A first virtual representative is allocated to the first user and a second virtual representative to the second user. The first and second virtual representatives are presented on the first terminal and on the second terminal. Information is transferred from the first user to the second user and vice versa by an animation of at least one of the first and second representatives and by an interaction between the first and second representatives, wherein at least one of the animation and the interaction takes place in response to a drag & drop command of a user, and wherein an animation of the first virtual representative takes place in response to a command of the first user and an animation of the second virtual representative takes place in response to a command of the second user.

The present invention relates to a method and a system by means of which at least two users can communicate with one another via appropriate terminals. Communication is broadened and supported through the use of virtual representatives.

### BACKGROUND

In addition to more conventional means of communication such as telephone, fax or e-mail there has for some time been a further communications service which has become known as “Instant Messaging” (IM). With this communications service several users using a client program can exchange written messages in real time or also “chat” with one another. A text inputted by a user is sent in real time to the other participating users. These can then respond in turn to sent messages by text input.

A disadvantage of Instant Messaging is that this form of communication is limited to the exchange of pure text messages. In order to overcome this disadvantage and to broaden the possibilities of expression in Instant Messaging, many users use so-called “emoticons”. Emoticons are character strings imitating a face or also “smiley” which are used in written electronic communication to express moods and feelings.

Even if the possibilities of expression within Instant Messaging can be slightly broadened thanks to “emoticons” there is still no further possibility here of communicating in particular emotions and moods to a chat partner in a multi-layered, clear, attractive and multi-media way.

### SUMMARY OF THE INVENTION

An object of the present invention is to provide a method and a system with which at least two users of telecommunications terminals can communicate with one another in real time in a multi-layered, attractive and multi-media way. The method according to the invention and the system according to the invention are in particular intended to make possible a particularly direct, versatile and varied communication of moods, emotions and feelings.

The present invention provides a method of telecommunication between at least two users over a telecommunications network wherein the first user is connected to the telecommunications network via a first terminal and the second user via a second terminal, and wherein a virtual representative is allocated to each user, with the following steps:
presentation of the two representatives on the first terminal and on the second terminal;
transfer of information from the first user to the second user and vice versa by an animation of at least one representative and by an interaction between the representatives.

For the sake of clarity, in the following the case of a merely two-way communication between a first and a second user is always described. However, the invention naturally also covers appropriately designed communications between three or even more users.

In the method according to the invention, communication between the two users is substantially broadened and improved through the use of virtual representatives. The users are now no longer tied exclusively to the written form for exchanging information, but can also immediately pass on information to the respective communications partner in vision and sound by animating their respective representative. The virtual representative represents not only the respective user, but also comprises communications functions, in particular the functions described below for a non-verbal communication. Thus each representative is not only to be understood as a graphic element, but also as a program element or object for an application program which runs on the terminal of the respective user for the purpose of communication with the other user. The representatives are thus small communications control programs. The representatives are therefore also called “communications robots”, “combots” for short, in the following.

By telecommunication is meant in the context of the invention communication between the two users over a certain distance, and very broadly understood. This means that all types of communication over all communications networks are included. This takes place for example over a telecommunications network, which can be for example a telephone network, a radio communications network, a computer network, a satellite network or a combination of these networks. The network according to the invention preferably includes the Internet or else the World Wide Web.

Both the first user and also the second user communicate with each other via so-called terminals. These terminals serve for telecommunication and make possible the exchange of information between the users in vision, sound and/or in written form. These terminals can be telephones, mobile phones, PDAs, computers or similar. The users can also communicate with one another via different devices in each case. The terminals are preferably Internet-capable computers or also PCs.

By “user” is meant in the context of the invention a natural person or else a human individual.

According to the invention a virtual representative (combot) is allocated to each user when telecommunication takes place. This virtual representative can also be called a doppelgänger or avatar. This is a graphic dummy which represents the respective user. For example, a user can have a known comic figure such as Donald Duck or Bart Simpson as virtual representative. The graphic figure is presented to the user on his terminal during the communication. Simultaneously, the user also sees a further graphic object, which stands for his communications partner.

Thus information, such as e.g. an expression of feeling, can be communicated in a novel way to a communications partner by animating the virtual representative of the communicating party accordingly. Additionally or alternatively an interaction between the two representatives can also be presented.

If a representative is animated this means that the appearance or sound of its graphic presentation changes with time. A representative is thus not merely a static picture or symbol, but is dynamic and can perform the most varied acts. Thus a representative can e.g. wave to show the greeting.

If an interaction takes place between two representatives this means that not only each representative is animated independently of the other. Rather, one representative reacts to the action of the other representative and vice versa. Thus an interactive transaction takes place between the two representatives, the two representatives influence each other and enter into a reciprocal relationship. Thus e.g. one representative can wave back in response to a wave from the other representative.

The animation and/or interaction of the representative preferably takes place in response to a user command, in particular in response to a drag & drop command from the user. Thus the user can control his representative individually in order to e.g. indicate his current mood to his communications partner by controlling the representative. Control takes place by a corresponding operation of the respective terminal, which is preferably a personal computer. If the terminal has a graphic user interface (desktop) with a mouse-type control the user can particularly easily by dragging and dropping (drag & drop), trigger an animation or interaction of his representative. For this, the user moves his mouse pointer onto a graphic image of the animation which his representative is to carry out and “drags” this image onto the graphic presentation of his representative. A predefined area of the desktop or a window or window area created by the application program can serve for this.

An animation of the representative of the second user can preferably also take place in response to a command from the first user and vice versa. The described interaction between the representatives is thus easily possible with this function. This function is useful in particular if one user wishes his representative to carry out an action which is to have an effect on the representative of the other user. Thus the first user can e.g. instruct his representative to throw an item at the representative of the other user. In response to the throw command from the first user and the graphic presentation of the throw at the representative of the second user, there is an appropriate “reaction” of the representative at whom it has been thrown in the form of an appropriate animation. An animation of the representative of the second user is thus triggered by a control command from the first user. Thus a kind of video or computer game can even develop between the two users using the two representatives. Preferably the first user can obtain such an animation of the representative of the second user by the described drag & drop onto the representative of the second user.

The animation and/or interaction taking place in response to a user command is preferably presented simultaneously, parallel and in real time on both terminals of the two users. This means that both users can follow the behaviour of the representatives in response to the inputted commands, live, as it were, on their respective terminals.

Depending on how quickly and directly the exchange via the representatives is to take place, the control commands inputted by the users to animate the representatives of the users can be processed differently. Thus a newly inputted user command can lead to a direct interruption of an ongoing animation or interaction; the interruption is then followed immediately by the new animation desired by the user. Instead of this the ongoing animation or interaction can also be completed first in response to a new user input, so that the desired animation follows on immediately from the completed animation. Furthermore when there are several user commands following in quick succession on both sides under certain circumstances the desired animations or interactions can be placed in a waiting list of the animations or interactions to be carried out. The animations indicated by the users are then processed in sequence according to the waiting list.

The interruption to a first animation or interaction triggered by the first user and a replacement of the first animation or interaction with an animation or interaction triggered by the second user and vice versa can also take place. If, for example, the first user triggers an interaction by which his representative fires an arrow at the representative of the second user, the second user could interrupt this interaction by instructing his representative to ward off the arrow with a shield. The first user could in turn interrupt this second interaction by triggering a further interaction and so on. Thus a regular interactive game of action and reaction can develop between the two users using the representatives.

The progress of the interaction can depend on predeterminable parameters which the users predetermine and/or are stored in the system in user profiles which are allocated to the users. The parameters can include e.g. personal information about the respective user, such as, say, his nationality, his place of residence or temporary location, his preferences and hobbies etc. Thus e.g. idiosyncrasies in communication, in particular gestures, can be taken into account which are specific to the respective nationality or culture group. Also, by means of data acquisition and statistical functions, the respective user profile can be managed by the system and brought up to date, so that the appropriate interactions are automatically used for the representative (combot) of the respective user or at least an appropriate selection is offered to the user, e.g. a number of the preferred interactions (favourites). The system thus has at its disposal a function which automatically changes and adapts the interactions using the parameters. The user can switch this auto-function on and off at any time.

According to a further independent inventive aspect, to further broaden the depth of communication between the users, a recognition of a speech or text input into his terminal by a user can also take place. The recognized speech or text input is then analyzed, so that its importance is detected.

Furthermore a video recognition (e.g. by means of a video camera) of the facial expression of a user and its analysis and interpretation can take place. Thus the facial expressions of a user can preferably be recorded and assessed for specific expressions of feeling.

Subsequent to the analysis and interpretation several suitable possibilities for animation or interaction can be provided to the user in tune with the sense of his speech or text input or his facial expression. If the user thus makes it known e.g. in writing, verbally or through his facial expression, that he is happy, appropriate animations expressing happiness (the animation “smile” or “laugh” or “jump” etc. . . . ) can be proposed to the user for the appropriate animation of his representative.

Instead of a proposal function, an animation of a representative and/or an interaction between the representatives in tune with the sense of the speech or text input or the facial expression can also take place directly or automatically. In this case the sense of a speech or text message or the facial expression can be automatically established, and consequently the behaviour of the corresponding representative can likewise automatically be matched to the sense of the speech or text message or of the facial expression. If the speech or text message or facial expression of a user thus says e.g. “I am sad” the representative of the user can automatically adopt a sad facial expression. Alternatively there can be a confirmation by the user first before the representative imitates the recognized sense. The automatic recognition of the sense of a text message can also be called “parsing”. The text is searched for keywords and terms for which appropriate animations and where appropriate interactions are offered to the user and/or automatically introduced by the system into the communication. Such a “parsing” function can also be applied appropriately to non-text messages, in particular to speech messages. Moreover, during analysis of the contents of the messages, information about the user can also be used which is retrieved from the user profile stored in the system. Thus information about writing and speech habits of the respective user can be stored there which are then taken into account during conversion into animations and interactions.

The additional function of analysis and interpretation of a facial expression, of a speech or text input of a user is advantageous in particular if, in addition to communication via the representatives, the two users communicate with each other in the usual way by text and/or speech messages (e.g. via VoIP and/or Instant Messaging) or webcams.

In order to make possible a particularly simple and intuitive input of control commands to the representatives, the presentation of the possibilities of animation and interaction of the representatives takes place in a tabular overview. The tabular overview is applied in terminals which provide the user with a graphic user interface. Thus, with the help of the graphically presented table which contains the available control commands in the form of small graphic symbols (“icons” or also “thumbnails”), the user can select an action which is to be carried out by a representative. The overview table can also be called grid, matrix or raster.

The tabular overview preferably has a fixed number of classes in which the possibilities of animation and interaction are collected and from which they can be retrieved. Thus the tabular overview can consist of a two-by-three matrix wherein each of the six fields of the matrix stands for one of the six finally fixed classes. The animations in the six classes are particularly preferably collected into the areas “mood”, “love”, “topics”, “comment”, “aggression” and “events”.

If, moreover, the users are provided with a drawing function to make possible a real-time transfer of a drawing by a user on his terminal to the other user on his terminal, yet another type of communication results for the users. Using a drawing tool a user can produce a drawing on his graphic user interface. The other user and communications partner can then track creation of the drawing in real time on his terminal. Thus information can also be sent which can be presented only with difficulty in writing or via the representatives.

Furthermore it can be proposed to integrate into the views of the two communications users a mood display which shows the present respective mood of the two representatives. This mood display can be accomplished in the form of a mood bar and/or in the form of a face laughing to a greater or lesser extent depending on the mood (“smiley”). Thus each user can directly see precisely what his own mood and that of the foreign representative looks like. The respective mood display can vary in the course of the animation of the representatives and as a consequence of the exchange.

If additionally an automatic animation of a representative also takes place in reaction to a change in the mood display, the behaviour of the representative is particularly varied and true-to-life. Thus e.g. the representative of the first user can automatically start to jump for joy if its mood display has exceeded a specific limit value.

The mood display can be presented in the most varied forms, e.g. even in the form of a “thermometer” or a “temperature curve”. The current mood or humour of the user can also be displayed by colouring or otherwise configuring the representative (combot). It is particularly advantageous if the depth of communications is also made to depend on the current mood. For this, the system assesses the current mood display and modifies the animations and/or interactions accordingly regarding the representative (combot) of this user.

The presentation of the two representatives at the first terminal preferably is a mirror image or inverted mirror image of the presentation of the two representatives at the second terminal. This means e.g. that each user always sees his representative on the left and the representative of the other user on the right. A clear allocation is thus guaranteed even if the representatives are identical.

Further particular advantages result if the following additional features are fulfilled:

The one animation of the at least one representative and/or the interaction between the representatives preferably takes place depending on predeterminable criteria, in particular criteria which are stored in a user profile which is allocated to at least one of the two users.

Moreover at least one of the two users can be provided with a selection of animations and/or interactions to be transferred. This can also take place depending on predeterminable criteria, in particular criteria which are stored in a user profile which is allocated to at least one of the two users. A selection of animations and/or interactions to be transferred is proposed to at least this user.

In this context details relating to at least one of the two users, in particular information regarding gender, age, nationality, mother tongue, speech habits or patterns, place of residence, interests and/or hobbies, can be predetermined as criteria.

It is also advantageous if one animation of the at least one representative and/or the interaction between the representatives takes place in response to a drag & drop command of a user, wherein the drag & drop command relates to the actual representative of this user or to the representative of the other user and wherein the animation or interaction takes place depending on which of the two representatives the drag & drop command relates to.

In connection with recognizing speech or text inputs or video recognition, this can take place depending on predeterminable criteria, in particular criteria which are stored in a user profile that is allocated to at least one of the two users. It is advantageous if the predeterminable criteria include details relating to at least one of the two users, in particular details regarding gender, age, nationality, mother tongue, speech habits or patterns, place of residence, interests and/or hobbies.

The animation of at least one representative and/or the interaction between the representatives can depend on the mood display which, for at least one of the two users, displays his current prevailing emotional mood. Thus it can be provided in particular that the automatic reaction of a representative in response to a received emotion depends on the current prevailing mood of the receiving representative. If, thus, e.g. the prevailing mood of a representative is well-disposed and this representative receives an aggressive emotion, the automatic reaction of the representative could be a simple shake of the head. However, if the prevailing mood of the representative receiving the aggression is negative, instead of simply slightly shaking his head he could automatically clench his fist and swear.

Conversely the mood display which, for at least one of the two users, displays his current prevailing emotional mood can be modified depending on the transferred emotion and/or interaction. Likewise the selection of animations and/or interactions to be transferred at least to one of the two users can be provided according to the mood display which, for at least one of the two users, displays his current prevailing emotional mood.

It is advantageous if the selection of animations and/or interactions to be transferred is provided in the form of assembled groups and/or classes. In this connection, the assembly of the classes and/or the selection of animations and/or interactions can take place automatically and pseudo-randomly controlled.

Finally, the present invention also comprises a system to carry out the methods according to the invention described above.

### BRIEF DESCRIPTION OF THE FIGURES

FIG. 1 shows an overall view of a user interface of a user for carrying out the method according to the invention;

FIGS. 2a to 2c show alternative embodiments of user interfaces according to the invention;

FIGS. 3a to 3f show a further alternative embodiment of a user interface according to the invention;

FIGS. 4a and 4b show an example of an interaction between two virtual representatives;

FIGS. 5a and 5b show two embodiments of the tables according to the invention for selecting a control command;

FIG. 6 shows different control possibilities which are available to the user with the help of the tables according to FIGS. 4a and 4b;

FIG. 7 shows the text recognition and interpretation (parsing) according to the invention;

FIGS. 8a to 8d show different processing possibilities of the control commands issued by the users;

FIG. 9 shows the respective inverted mirror view of both users;

FIGS. 10 to 28 show by way of example the progress of a communication between two users using the method and system according to the invention;

FIG. 29 shows an example of a complex communication with text-based elements and with elements configured according to the invention.

### DESCRIPTION OF PREFERRED EMBODIMENTS

Preferred embodiments of the present invention are now described by way of example for a better understanding.

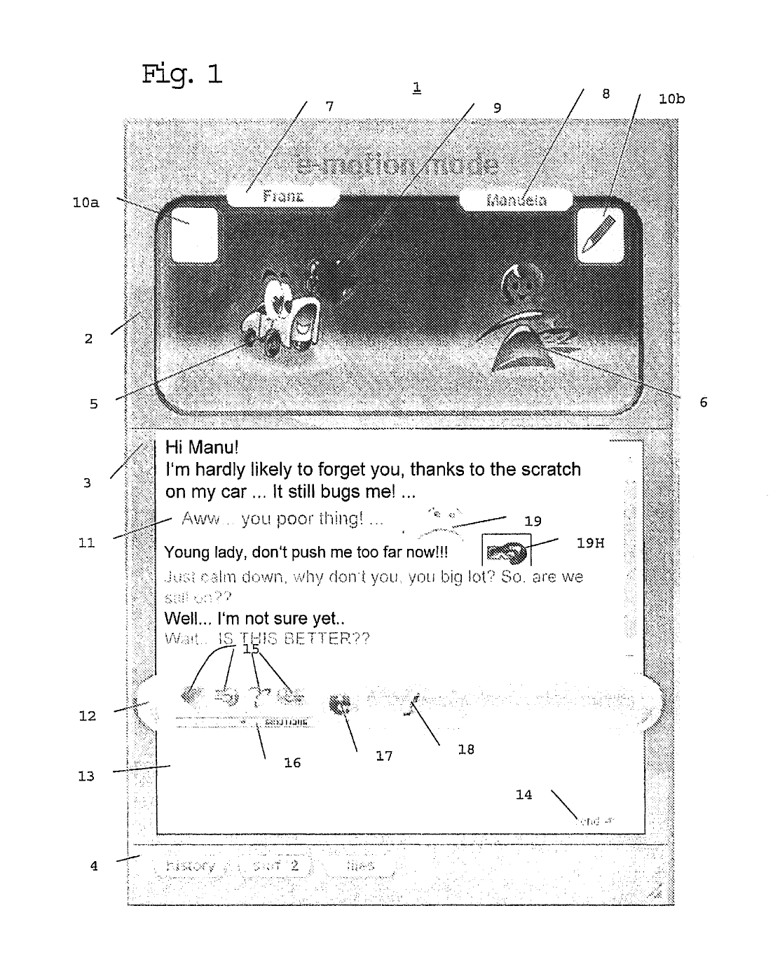

Below it is assumed that a first user named “Franz” is in communication with his friend “Manuela”, who represents the second user. The two are communicating over the Internet by means of their respective computers. Both Franz and Manuela have a communication application running on their respective computers for communication with each other. The user interface 1 of this application is represented by way of example in FIG. 1.

The user interface 1 is the interface which Franz uses to communicate with Manuela. FIG. 1 thus reproduces what Franz sees on his screen when communicating with Manuela. On the screen of her computer Manuela has an interface analogously structured to the user interface 1.

Below only the structure of the user interface 1 is described.

The user interface 1 is accomplished as an independent window with three main sections 2, 3 and 4. Section 2 can be called animation section. The virtual representatives 5 and 6 of Franz and Manuela are presented in this section. Section 3 is the text and control section. The text messages exchanged between Franz and Manuela are presented here. The control panels for controlling communication are also accommodated in section 3. Finally, section 4 is the menu bar.

The two virtual representative 5 and 6 (combots) of both users are to be seen in the animation section 2. The virtual representative 5 of Franz is a car, while the virtual representative 6 of Manuela is a doll. Nametags 7 and 8 above serve to better allocate the representatives. As can be seen in FIG. 1 Franz's representative 5 is currently in animation phase and sending hearts 9 to Manuela's representative 6. In this way Franz is expressing his affection for Manuela through his representative 5.

Small windows 10a and 10b are arranged above the representatives 5 and 6 in the respective corners. These windows show what actions are being carried out at this precise moment by the respective user. If e.g. a pencil appears in window 10b then Franz knows that Manuela is currently using the drawing function described later in detail.

The text and control section 3 is divided into a messages area 11, a control bar 12 and a drafting area 13. The text messages already exchanged between Franz and Manuela are to be seen in the messages area 11. In order to compose and to send a text message to Manuela, Franz uses the drafting section 13. Franz can enter a text message to Manuela into this section 13 by means of his keyboard. As soon as Franz has produced the text message, he can send it to Manuela by pressing the button 14. The sent speech message then appears both in Franz's messages area 11 and in Manuela's messages area.

In order to control his representative 5 Franz uses the control bar 12. The control bar 12 has several buttons 15. Different animations of the representatives 5 and 6 can be triggered by these buttons 15. Thus the “heart animation” indicated in FIG. 1 can be triggered by dragging and dropping the heart symbol onto Franz's car. By dragging the boxing glove onto Manuela's doll, the representative 5 of Franz can thus be made to punch the doll.

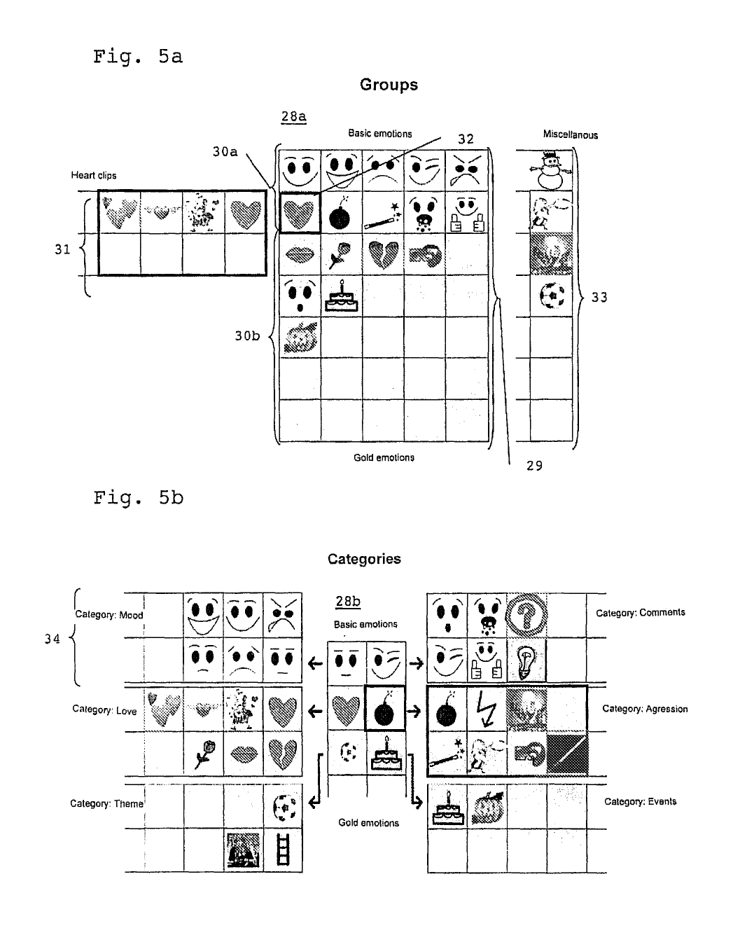

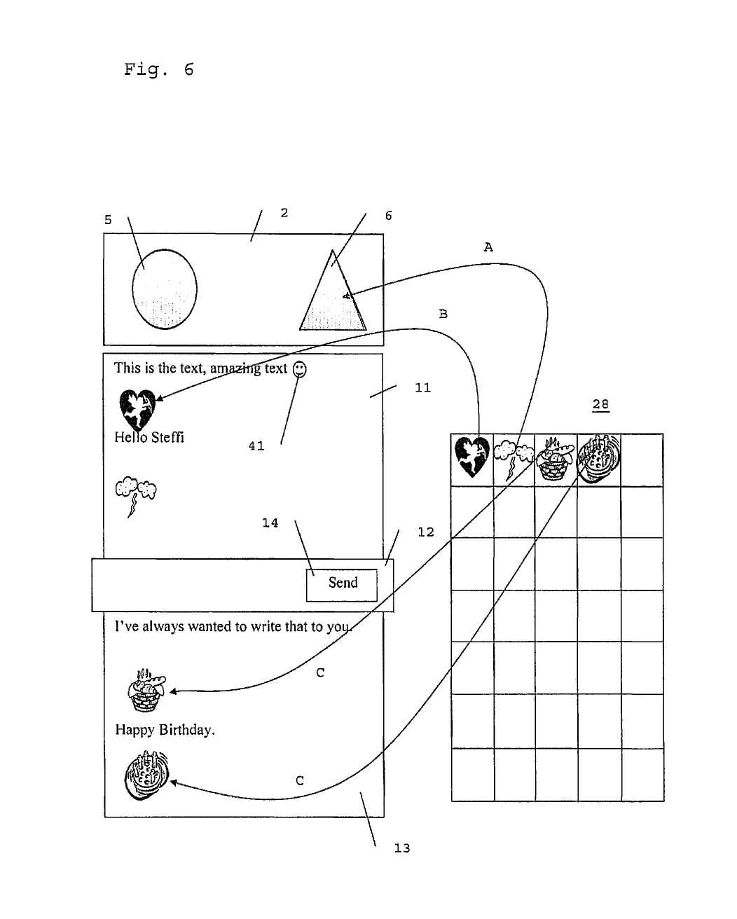

An overview table with further control commands can be opened by pressing the button 16, as is presented by way of example in FIGS. 5a and 5b.

Button 17 makes possible the opening and closing (showing and hiding) of the animation section 2.

Moreover, via the button 18 presented as a pencil symbol, Franz can draw free-hand in the messages section 11 any desired figures which are understood in real time in Manuela's messages section. An example of such a drawn figure is emphasized by the reference number 19. Moreover, in the context of the section 11 the already-exchanged emotions are also displayed symbolically, i.e. the emotions forming part of the history of this still ongoing communication are displayed. Here, e.g. an emotion given the reference number 19H, and presented as a “boxing glove” is displayed, a rather aggressive emotion which “Franz” had previously sent to “Manuela”. By clicking on the symbol 19H of this historic emotion it can immediately be spontaneously repeated.

A history where appropriate of all past communications sessions can be retrieved via the menu bar 4 (by pressing the “history” button). Moreover it is also possible to access one's own files (by pressing the “files” button) in order, where appropriate, to send these to the communications partner. Finally, a session for joint surfing on the Internet can also be started via the button “surf*2”.

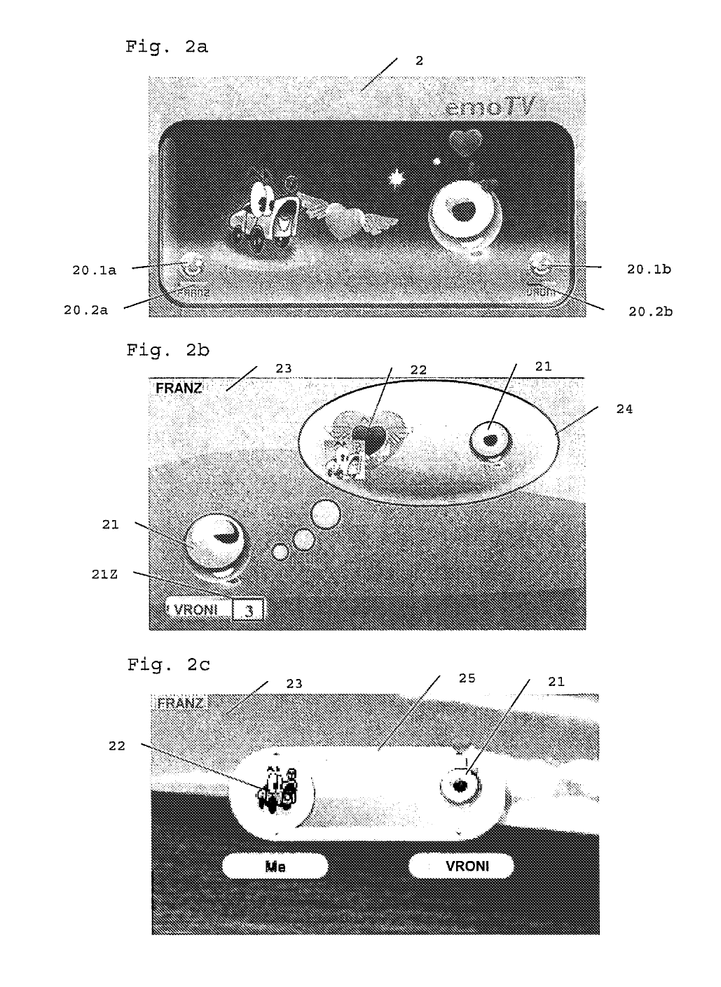

FIG. 2a shows an alternative configuration of the animation section 2. Unlike FIG. 1, here section 2 additionally has mood displays 20.1 and 20.2. Mood display 20.1 is a stylized face (a “smiley”) which by its facial expression illustrates the current mood of the respective representative and thus of the corresponding user. As can be seen, “Franz” is in a better mood than “Vroni”, as the laugh of the “Franz” mood display 20.1a (smiley) is wider than that of the “Vroni” smiley 20.1b. The mood display can alternatively or additionally also be accomplished in the form of mood bars 20.2a and 20.2b respectively. Here the length of the bar indicates the quality of the mood.

FIGS. 2b and 2c show, compared with FIG. 1, two further variants of the presentation of the interaction between two virtual representatives. The desktop of the user “Franz” is presented in each case.

In the case of FIG. 2b the virtual representative (combot) 21 of his communications partner “Vroni” is stored on the desktop 23. If “Franz” now wishes to send “Vroni” an emotion, he does so by clicking on the mouse or dragging & dropping onto “Vroni”'s combot 21. In this case of a so-called “sent emotion” the presentation of a thought bubble 24 appears immediately on the desktop 23 of the sender (“Franz”) as FIG. 2c shows. Both combots 22 and 21 and the transfer of the emotion itself here e.g. a flying heart which is flying from Franz's combot 22 to Vroni's combot 21, are presented inside the thought bubble 24. Everything appears in mirror image on Vroni's desktop (not presented).

In the case of a “received emotion”, the following happens on the receiver's desktop: initially, “Vroni”'s representative 21 is as a rule no longer heeded by the receiver “Franz”. However, allocated to the stored representative 21, a thought or speech bubble 24 can suddenly and automatically appear if the communications partner “Vroni” has sent a corresponding animation command from her computer to the computer of the user “Franz”. The animation of the two representatives 21 and 22 then takes place in the opened thought bubble 24.

If a user has stored several representatives of different communications partners on his desktop, the user can also direct a communication to several communications partners simultaneously. If the user e.g. wishes to send the same animation to two users simultaneously, he can combine the two corresponding representatives into a group. The user can send the desired animation to both communications partners in a single process by a single “drag & drop” onto the formed group. The most varied groups can be created using this “intelligent” formation of representative groups, such as e.g. temporary or else permanent groups. Several individual representatives can also be combined into a single group representative. The group representative (“Groupcombot”) is an individual representative with whose help the user can enter equally into contact with a whole group of communications partners.

Additionally, the system provides the following reference or notice function: if the receiver “Franz” does not respond to this emotion by manually reacting to it if the system does not cause an automatic reaction, a pointer 217 to this received emotion is displayed at Vroni's combot 21. This pointer 21Z is e.g. the current number of emotions to which there has yet been no response. Should the potential receiver “Franz” thus not be present for incoming emotions, he can subsequently recognize immediately whether, and how many, emotions have arrived during his absence and can then react to them.

The system establishes whether the potential receiver has noticed or missed the emotions on the basis of monitoring the receiver's activities. If e.g. the receiver performs no mouse or keyboard inputs during the presentation of the emotion and for at least five seconds thereafter, the system assumes that the receiver has missed the animation. Alternatively or additionally an activity recognition can take place via a video camera which is connected to the receiver's computer. Using the camera, the system checks whether the receiver is present. The video camera can also be used by the receiver as an input. The receiver can then, e.g. by hand movements which are recognized by the camera, send commands direct to his computer e.g. to control his combot or react to a received emotion.

In an additional step the camera can even recognize the user's body language, preferably in the form of a real-time monitoring. The behaviour of the user is constantly recorded via the camera. By means of recognition or interpretation software the system can interpret the behaviour of the user and animate the virtual representative in real time in tune with the user's behaviour. Thanks to the camera recording, it can e.g. be established that the user has just adopted an attitude that indicates that he is sad. The user's combot will then automatically simultaneously express the user's sadness. Camera recognition allows the combot to, as it were, imitate any behaviour of the user. The video camera detects the mood or attitude or even the air of the user. The detected mood is then automatically transferred to the combot by the system. Thus if the user e.g. clenches a fist, this movement is recorded by the camera then interpreted by the system and finally causes the user's combot to re-enact the user's movement: the combot clenches his fist, just like the user.

A particularly intuitive communication can take place via the combots with the just-described constant observation of the user. The user need not issue his combot with active commands, but merely needs to sit at his computer and behave naturally. The user's unconscious, direct and intuitive reactions during the communication are transferred wholly automatically directly onto the combot without the need for a conscious initiative to that effect on the part of the user.

If a receiver has missed an animation, a pointer 21Z is displayed at the corresponding combot. Additionally, an entry concerning the missed emotion is made in a logbook provided for the purpose (so-called “history”). The receiver can once more trigger or replay the missed animation via the logbook and/or the pointer 21Z. Thus the system provides a type of recorder or memory function for missed animations.

A speech bubble is preferably presented in the case of a received emotion, but a thought bubble in the case of an outgoing emotion. The different manner of presentation can, however, relate to whether an emotion is already transferred or not. If a user only wishes to prepare the transfer of an emotion (editing mode and/or preview mode), a thought bubble appears on his desktop. Initially, nothing yet appears on the desktop of the communications partner. However, as soon as the emotion is transferred (interaction mode) a speech bubble appears on both desktops. FIG. 2c shows another variant:

In FIG. 2c the two virtual representatives 21 and 22 are stored on the respective desktop 23 in FIG. 2c. The animation takes place here by combining the two representatives in an overall presentation, a so-called “arena” which preferably has the form of a tube or else a cylinder 25.

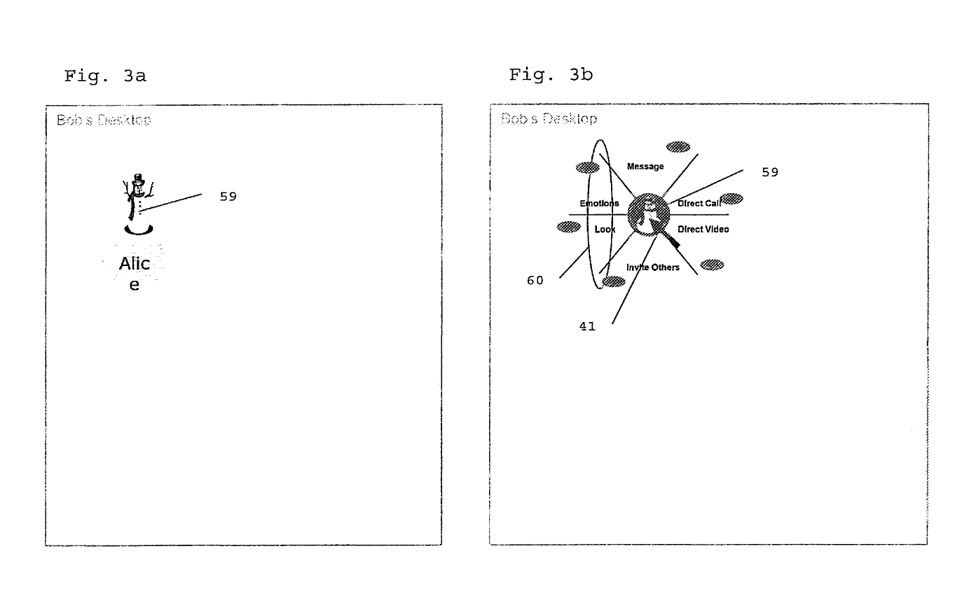

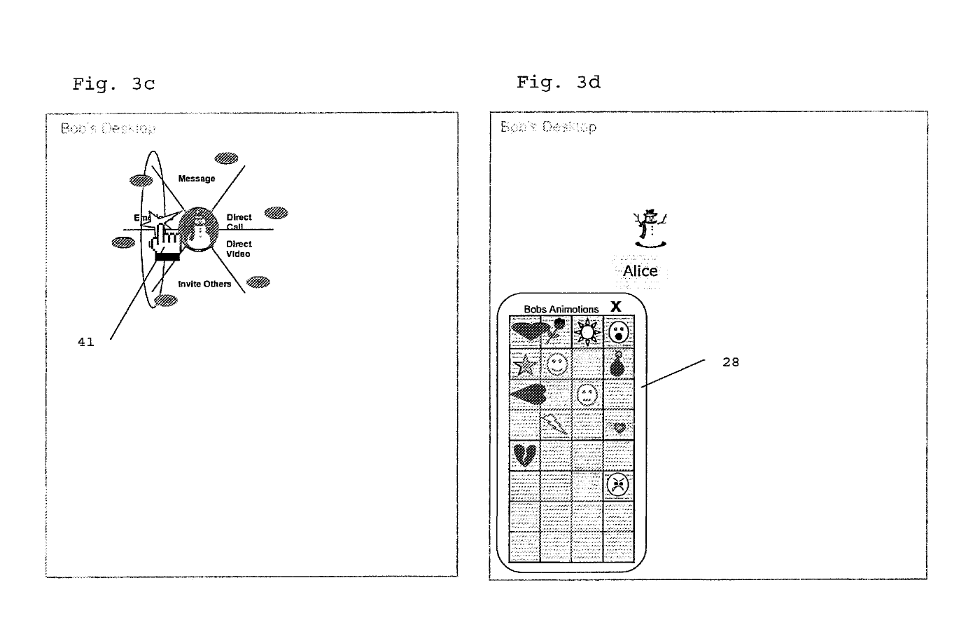

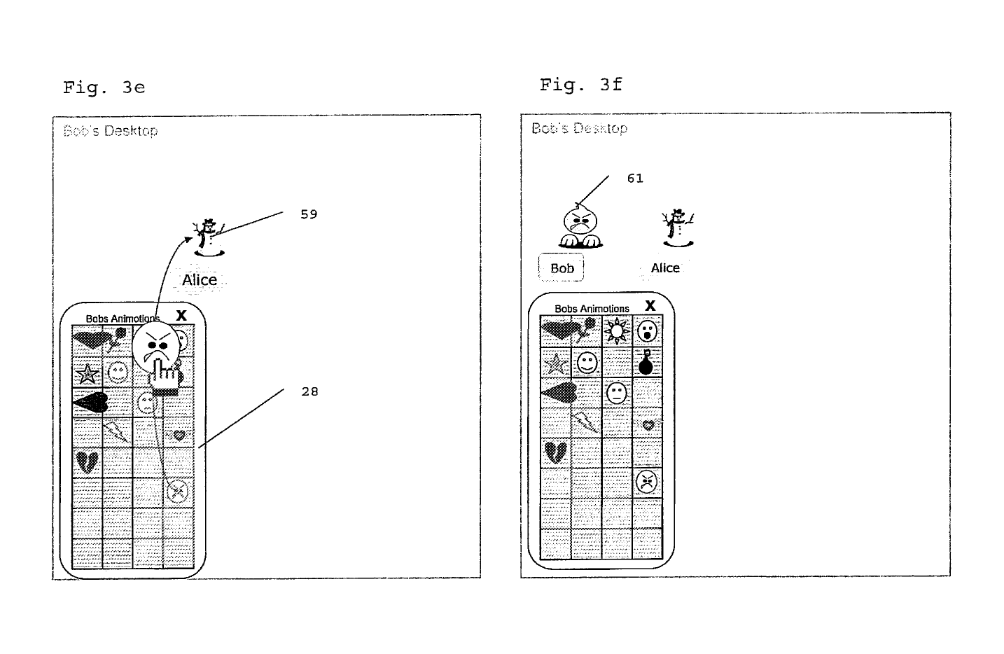

FIGS. 3a to 3f illustrate a further variant of the operation and interaction of the virtual representatives. FIG. 3a shows the desktop, i.e. the screen surface of a user named Bob. On his desktop Bob has stored a representative 59 in the form of a snowman. The representative 59 is allocated to Bob's friend Alice. Bob can communicate with Alice via the representative 59.

If Bob now wishes to communicate with Alice, he simply moves his mouse cursor 41 onto the representative 59. As soon as the cursor 41 is over the representative 59 (so-called “MouseOver”) a circular menu 60 automatically appears which surrounds the representative 59 (see FIG. 3b). By clicking on a menu section, Bob can now trigger various actions. Alternatively, the menu display and selection can take place such that Bob clicks on the representative 59 so that the menu appears, keeping the mouse button depressed in the process, then when the mouse button is pressed, moves the cursor 41 onto the corresponding menu point and finally selects the menu point by releasing the mouse button (so-called “release”).

If Bob e.g. now activates the “message” menu section he reaches an application with which he can produce a text message for Alice. If Bob selects the “emotions” menu section with his cursor 41 (see FIG. 3c) an overview table 28 appears (see FIG. 3d) as is to be seen in detail also in FIGS. 5a and 5b.

Numerous icons are listed in the overview table 28. Bob can place one of these icons on Alice's representative 59 by clicking, dragging and dropping (drag & drop). This is presented by way of example in FIG. 3e. Bob drags an “angry smiley” onto the representative 59 in order to thus let Alice know that he is in a bad mood. Once Bob has dropped the smiley a further representative 61 (see FIG. 3f) automatically appears on Bob's desktop. The representative 61 represents Bob and displays the emotion selected by Bob. As soon as the animation of Bob's representative is completed, it disappears again from Bob's desktop.

The animation selected by Bob also manifests itself on Alice's desktop such that the representative stored there which stands for Bob carries out the animation selected by Bob. Alice's representative does not appear on Alice's side.

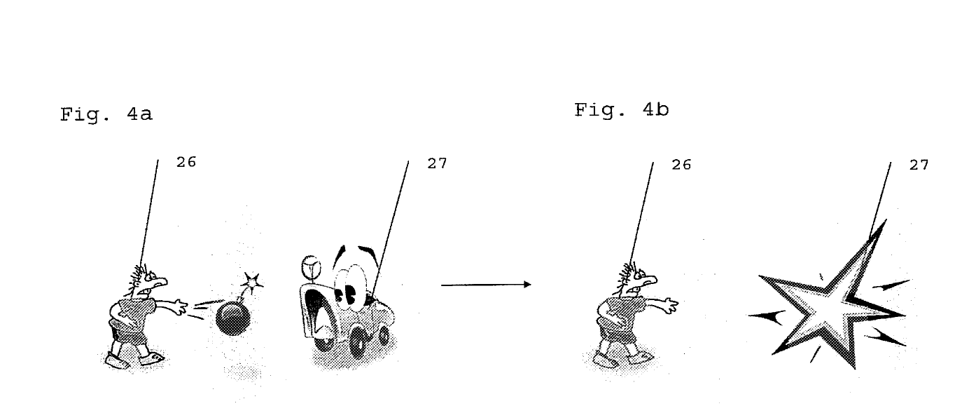

The FIGS. 4a and 4b show by way of example a typical interaction between two virtual representatives 26 and 27. The representative on the left 26 (“little man” combot) has been animated by his owner, by selection of the animation command “bomb”, to throw a bomb at the representative 27 (“car” combot) of the communications partner. As a consequence the virtual representative 27 is hit by the bomb and explodes (see FIG. 4b). The user behind the representative 26 may e.g. have selected the action “throw bomb” in order to express his anger about the communications partner opposite.

FIGS. 5a and 5b illustrate two embodiments 28a and 28b of the command table which can be called up by pressing button 16 (see FIG. 1).

All the actions which can be carried out by means of a virtual representative (combot) are presented in table 28a in an overall grid 29. Each available animation is presented by a corresponding square icon in the table 28a. The icons can each be allocated according to common groups (e.g. according to “love”, “friendship”, etc.). The overall grid 29 is divided into two sections 30a and 30b. The basic animations (“basic emotions”) which are freely available to each user, such as laughing, crying etc., are located in the first section 30a. On the other hand special emotions (“gold emotions”) which are peculiar to each user are located in the second section 30b. These idiosyncrasies of the representatives can be acquired by a user e.g. bought, exchanged or traded with other users.

It is also provided that in the starting table 29 (overview table) an icon not only stands directly for an emotion or animation, but representatively for a whole group of animations. Thus the heart icon 32 stands for the group of “love animations”. By pressing the icon 32 a further subtable 31 is opened from which the user can then select the desired love animation for his representative. A group thus comprises several variants of a basic presentation of an emotion, such as e.g. the heart presentation described here.

Those animations which cannot be allocated to a group are presented in a separate column 33.

In the embodiment according to FIG. 5b another type of distribution of the emotions is shown, wherein the overview table 28b is limited to six fields. Each of these fields stands for a whole class of animations. The respective class (e.g. class 34 “mood”) is shown by pressing the corresponding field in table 28b. The desired animation can then be selected within the class. Another class comprises e.g. all types of aggressive emotions and is symbolized in the starting table 28b by a bomb. The subtable which contains various types of emotions for selection opens by clicking on this symbol. The emotions collected within a class differ not only with regard to their form of presentation, but also fundamentally. This means that various types of emotions can be allocated to a class. They have a common meaning, statement of content or prevailing mood. The aggressive emotions class described here comprises e.g. a bomb animation, a lightning animation or a shooting animation.

FIG. 6 illustrates how the desired animation is selected and triggered by a user with the help of a table 28. There are essentially three variants A to C, wherein the first two variants are carried out using the “drag & drop” principle. The three variants are indicated by corresponding arrows.

In variant A the user drags the selected icon onto the corresponding representative and drops it there. The thus-operated representative then immediately carries out the desired animation. In the example according to FIG. 6 a thundercloud is selected and dragged onto the foreign representative 6. The consequence of this is that a thundercloud is sent from the actual representative 5 of the user to the foreign representative 6 and soaks him.

In variant B the icon is dragged into the messages area 11 and dropped there. This leads to the selected icon appearing in the messages area of the respective communications partner. By clicking on the icon the communications partner can then trigger the animation sent by the counterpart.

In variant C the icon is simply clicked on by the user. The icon is thereby integrated into the drafting area 13 at the cursor position current there. Upon integration of the icon a suitable text can additionally automatically be offered to the user. If the user thus e.g. clicks on the “birthday cake” icon the “Happy birthday!” text can also appear above the “birthday cake” in the drafting area 13.

By pressing the send button 14 the written text message is sent with the integrated icon to the communications partner.

In FIG. 6 a small face which is also called “emoticon”, is also to be seen in the messages area 11. Such faces, which express a specific mood, can be inserted into the message text as shown. For this, the user need only input the character string of the emoticon desired by him, e.g. :-), when writing a text message in the drafting area 13. This character string is then automatically converted into the corresponding face, here [symbol] . Upon operation of the send button 14 the text complete with emoticon is then sent to the communications partner.

Each individual emotion from the selection of emotions displayed in table 28 can also be immediately activated by double-clicking.

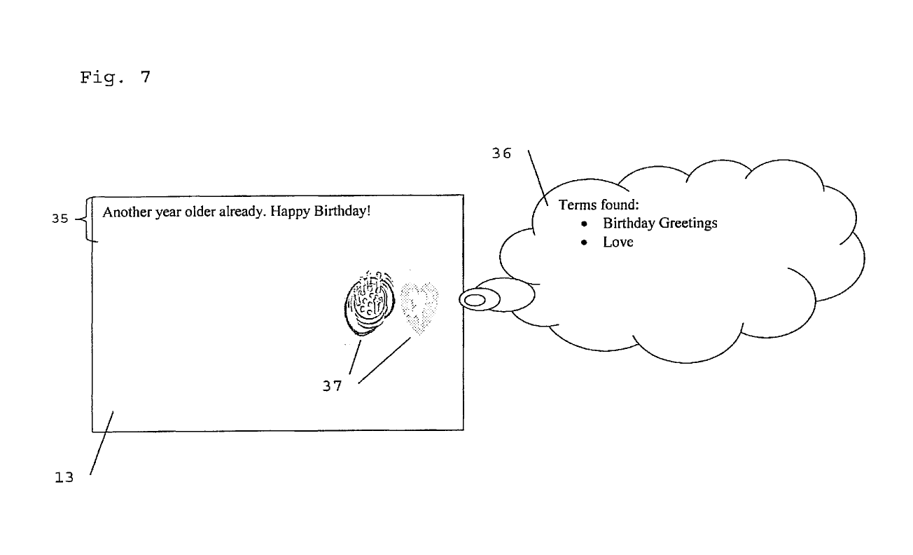

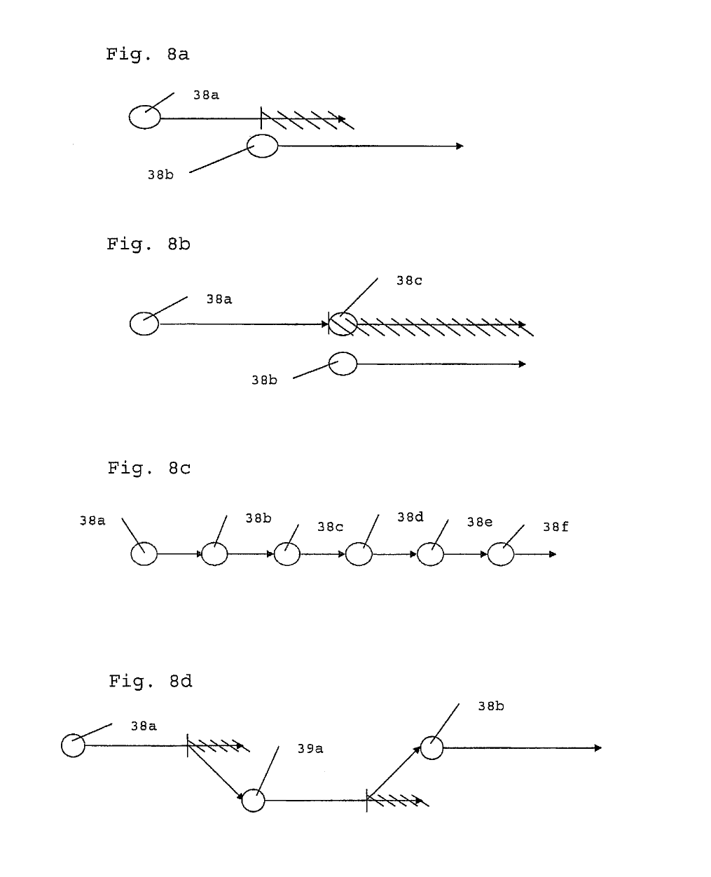

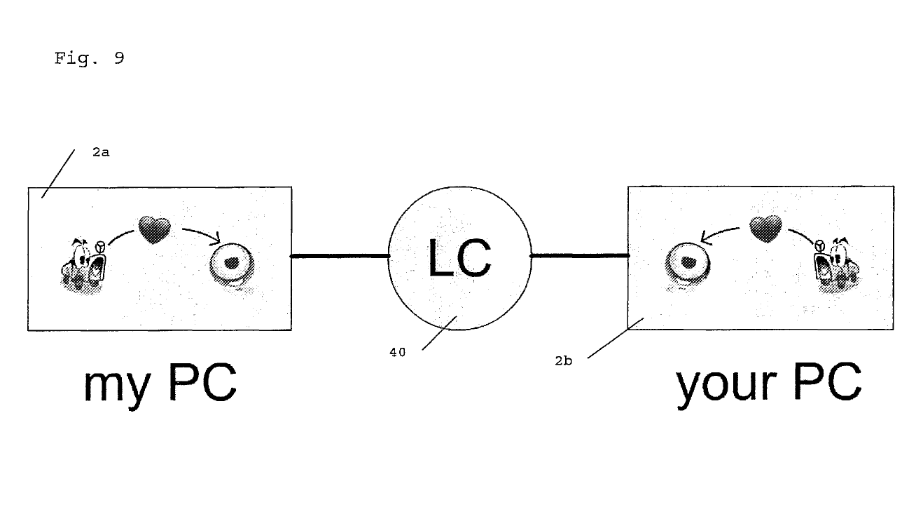

Automatic text recognition and interpretation (“parsing”) is presented in FIG. 7. When a user inputs a text 35 into his drafting area 13, its sense is automatically ascertained. The ascertained terms are then presented to the user, here in the form of a speech bubble 36. Simultaneously, two animations very suited to the sense of the just-inputted text are proposed to the user in the form of the icons 37. In the example according to FIG. 7 the user has inputted a greetings text with birthday wishes. Accordingly, a “love animation” and a “birthday cake animation” are proposed to the user. It is also provided that the animation of the representative in response to the sense of the inputted text is automatic, without the possibility of selection by the user.

Various alternatives for processing the animation commands issued by the user are illustrated in FIGS. 8a to 8d.

With the alternative according to FIG. 8a an animation 38a of the representative is immediately interrupted and replaced by a new animation 38b when the user issues his representative with a command to carry out the new animation 38b. There is a direct and delay-free implementation during this processing of the control commands, so that the behaviour of the representative has a rapid and dynamic effect.

Unlike FIG. 8a, in the alternative according to FIG. 8b the animation is completed first before the new animation 38b takes place. The originally proposed following animation 38c is suppressed.

With the alternative according to FIG. 8c all the animations triggered by the users are executed in linear succession. There is no suppression of animations. The requested animations are also placed according to their chronological order into a so-called “playlist” and carried out successively.

It is illustrated in FIG. 8d how a repeated interaction between two representatives can be processed and reproduced. A first user has his representative carry out an action 38a. This is then interrupted by a replica of the representative of the second user 39a, which for its part is carried out instead until the representative of the first user again reacts through the action 38b.

The animation sections 2a and 2b of a first and second user are presented mirror-inverted in relation to one another in FIG. 9. The first user and second user employ their animation sections 2a and 2b respectively in the manner described in order to exchange emotions with each other via their representatives. The exchange takes place over the network 40 (e.g. the Internet). For both the first user (“my PC”) and the second user (“your PC”) the user's own representative is presented on the left and the foreign representative on the right, so that a mirror-image view results. When communicating via the representatives both users see the same sequence simultaneously in their respective animation sections. Thus it could be said that both users see “everything”, i.e. the totality of the process in progress.

For the rest, it is also provided that virtual representatives can be bought, collected and exchanged by users. Thus some representatives may exist only in limited editions or even be unique, so that different representatives have a different commercial value. The sale and dissemination of the virtual representatives can be substantially improved by this measure.

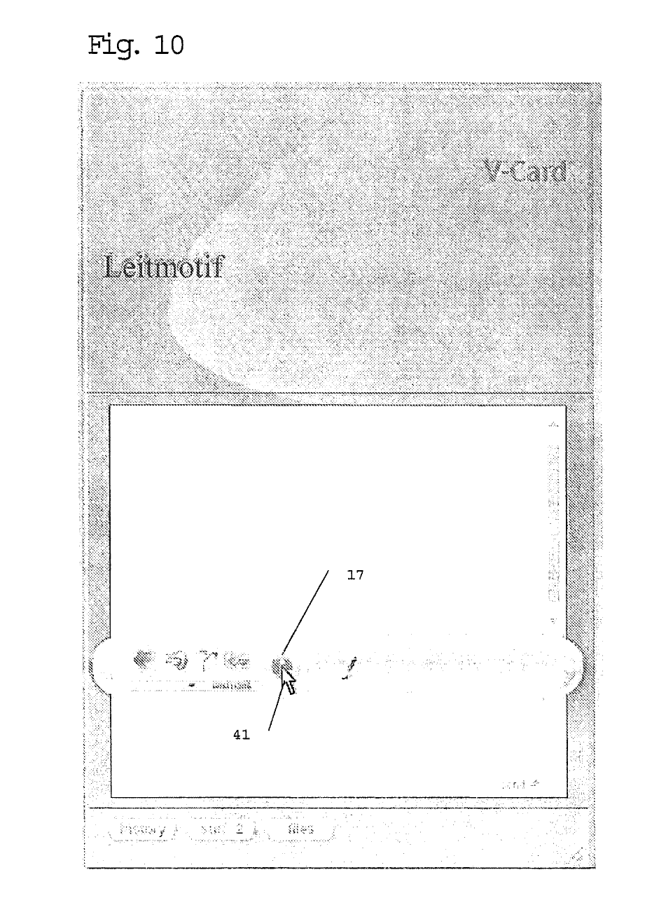

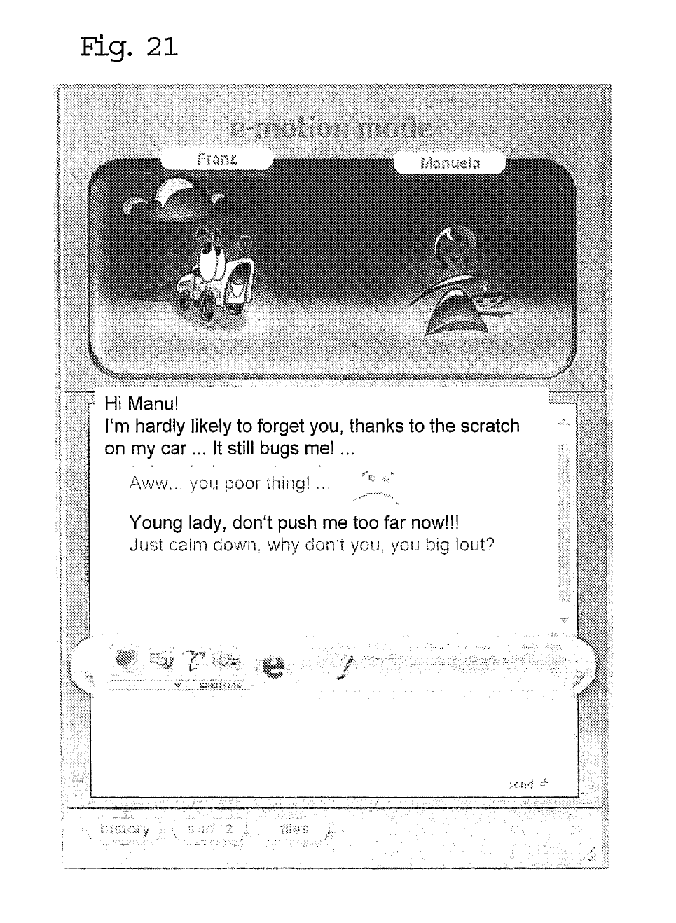

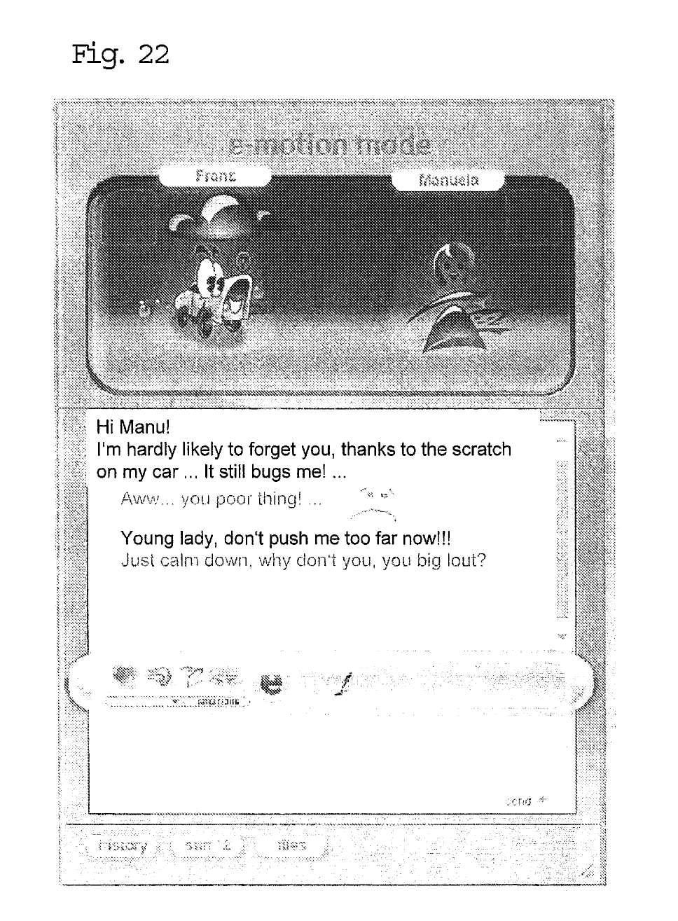

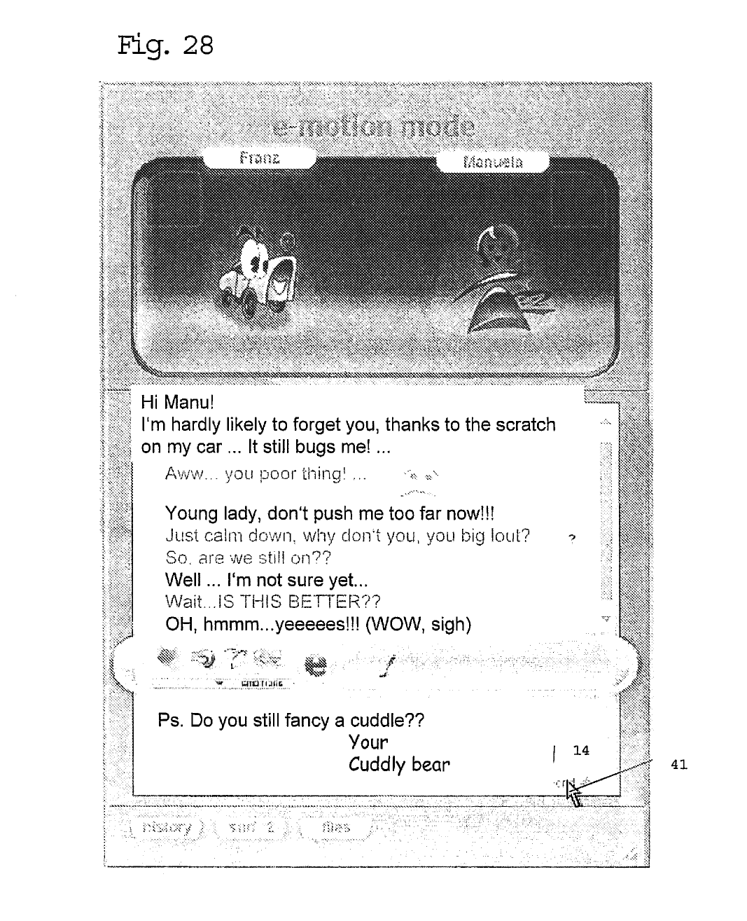

FIGS. 10 to 28 show an example of a communication such as could take place between Franz and Manuela. FIGS. 10 to 28 each reproduce snapshots (“screenshots”) of Franz's user interface 1. FIG. 10 represents the start of the communication and FIG. 28 the end.

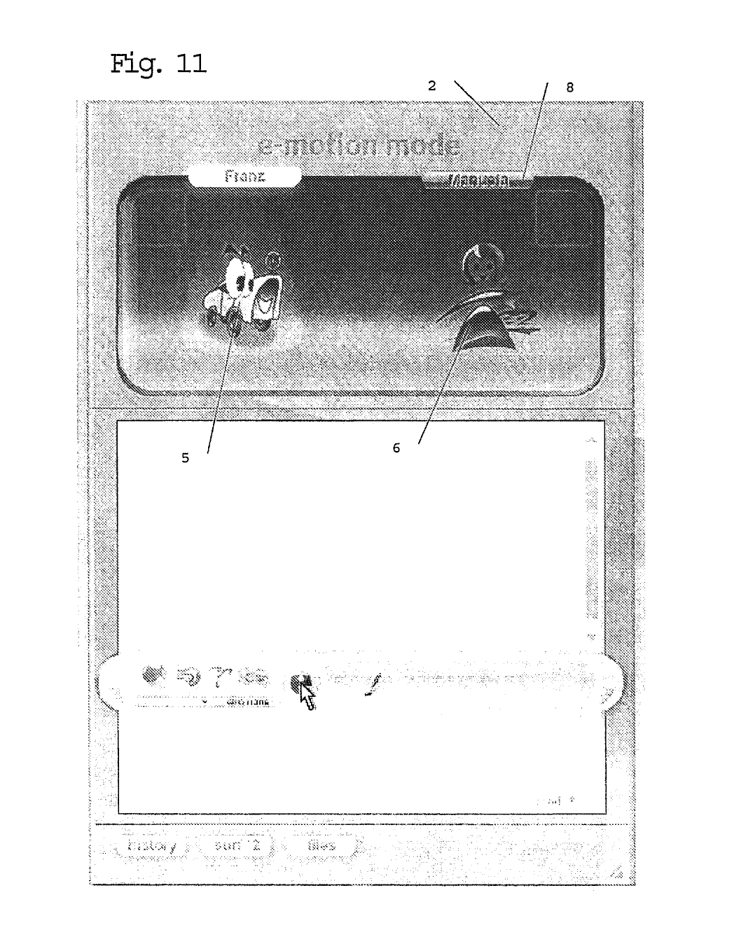

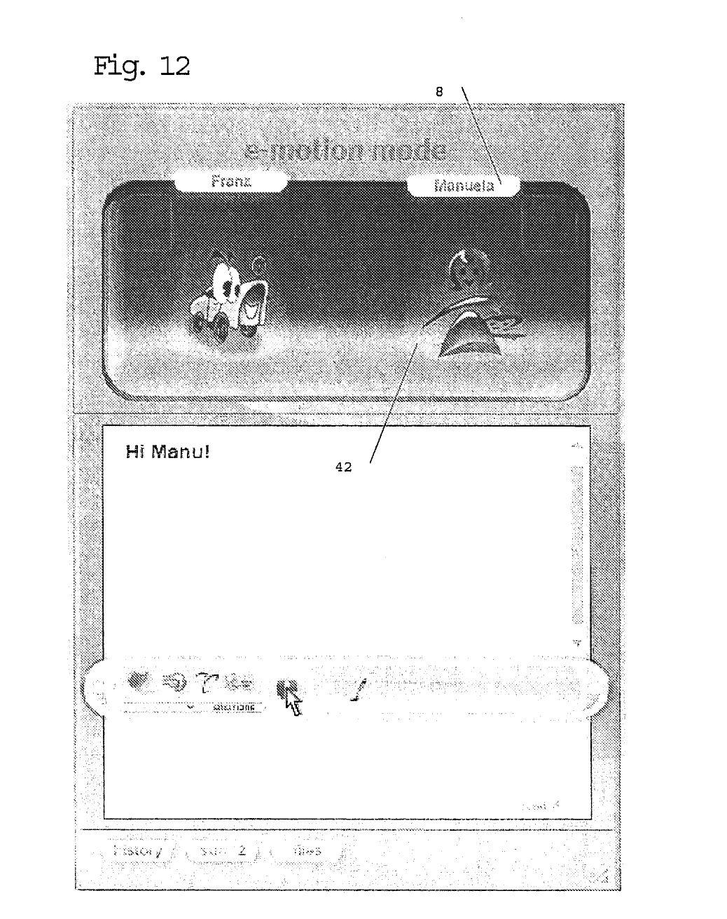

In order to start a communications session with Manuela, Franz operates the E button 17 with his mouse cursor 41 (see FIG. 10). The animation section 2 is thereby opened, in which the virtual representatives 5 and 6 of Franz and Manuela are presented (see FIG. 11). Manuela's nametag 8 is greyed-out, which means that Manuela is not yet in contact with Franz, i.e. Manuela is still “offline”. In FIG. 12 Manuela is now “online”, because Manuela's nametag 8 is now highlighted just like Franz's. Moreover, a spotlight 42 is now likewise trained on Manuela's representative.

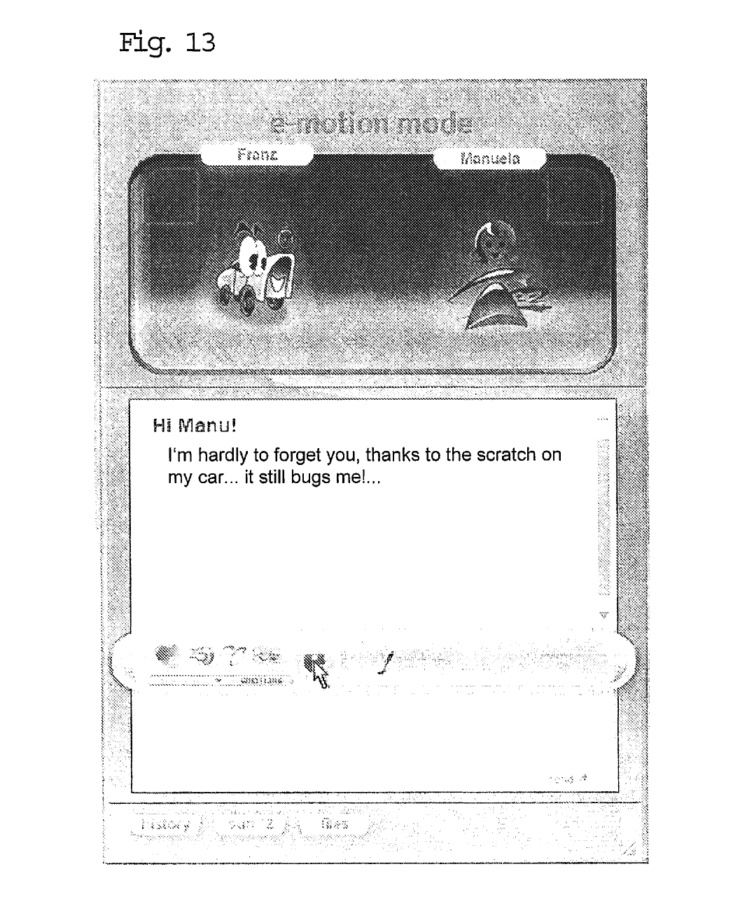

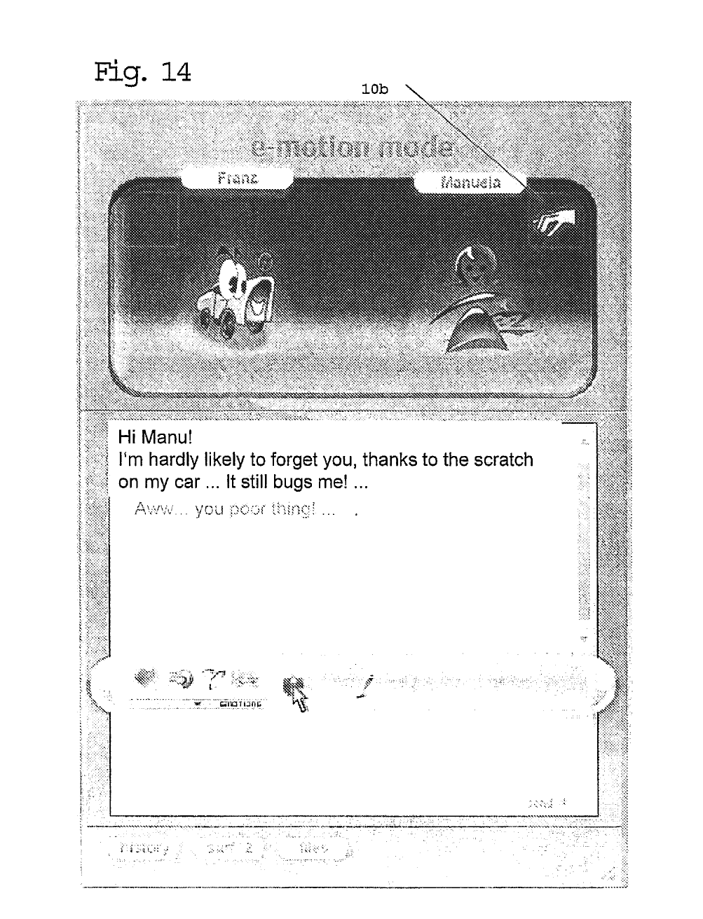

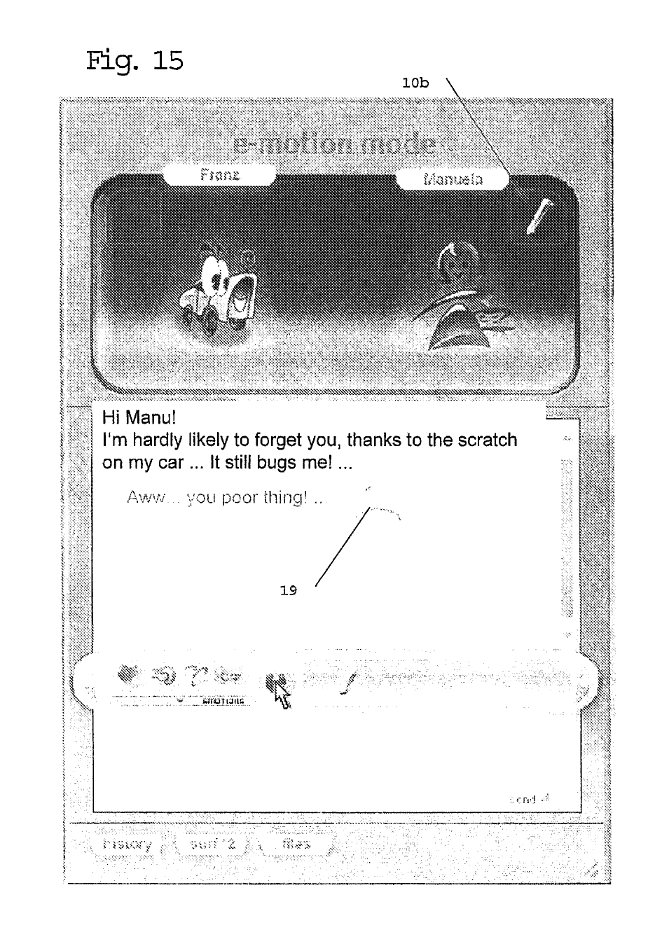

As can be seen in FIG. 13, Franz has sent Manuela a first text message, to which Manuela also immediately replies (see FIG. 14). While Manuela is inputting her text, a hand appears in Franz's window 10b, which indicates that Manuela is carrying out an action right now. Subsequent to her text input Manuela indicates a “sad face” 19 with the already described drawing function. Using the pencil presented in the window 10b, Franz can see that Manuela is drawing right now (see FIG. 15).

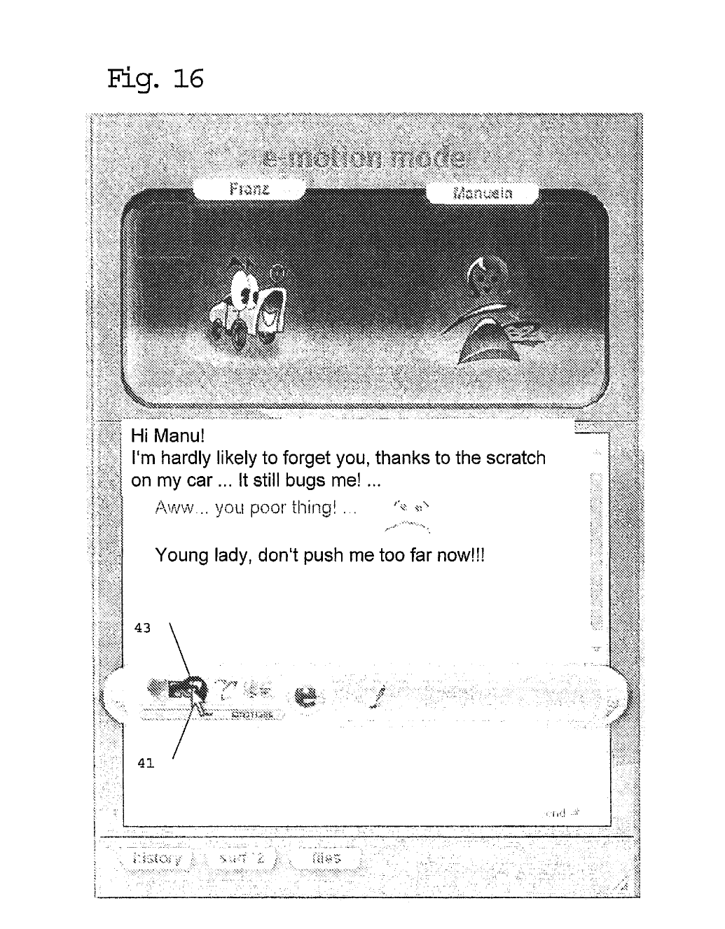

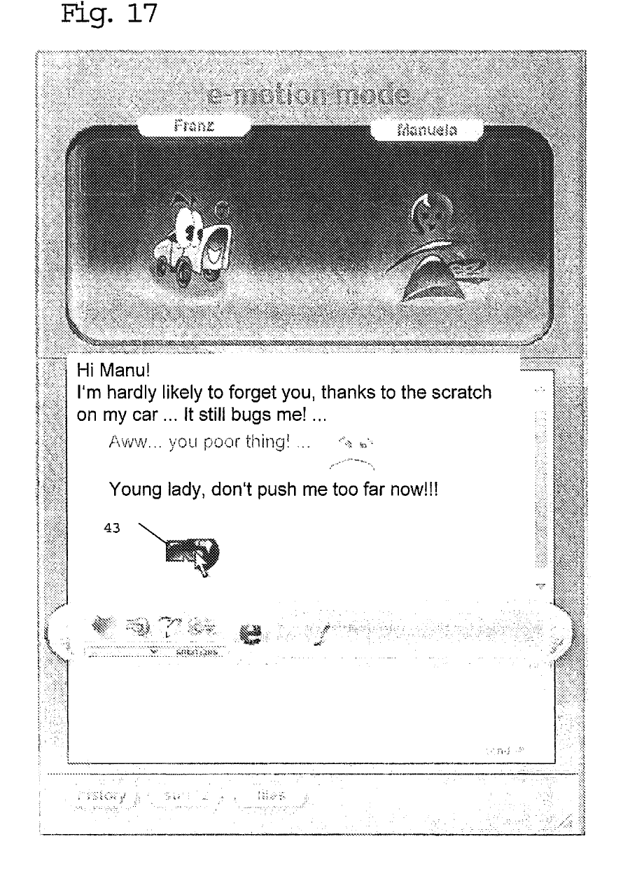

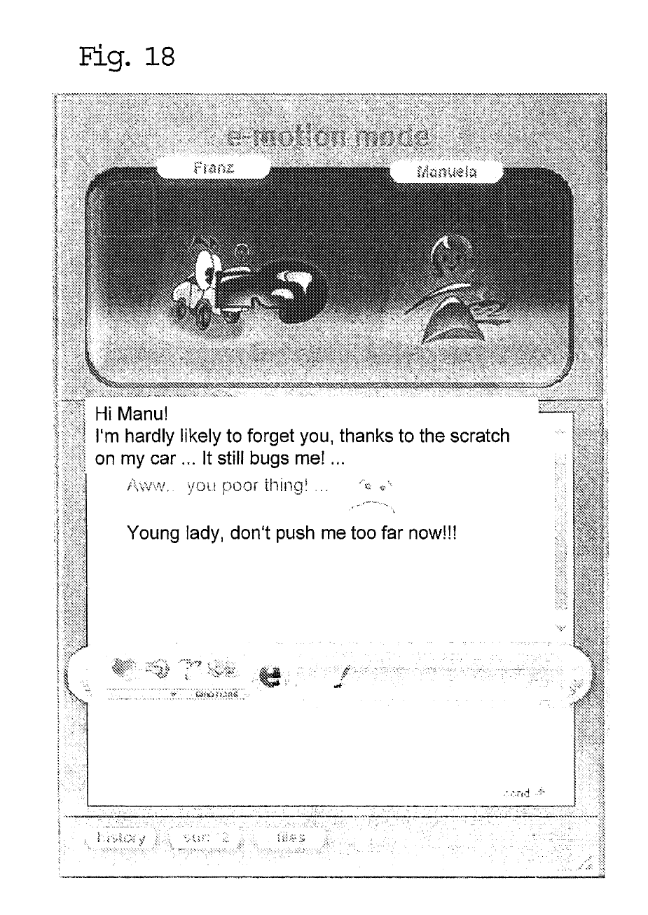

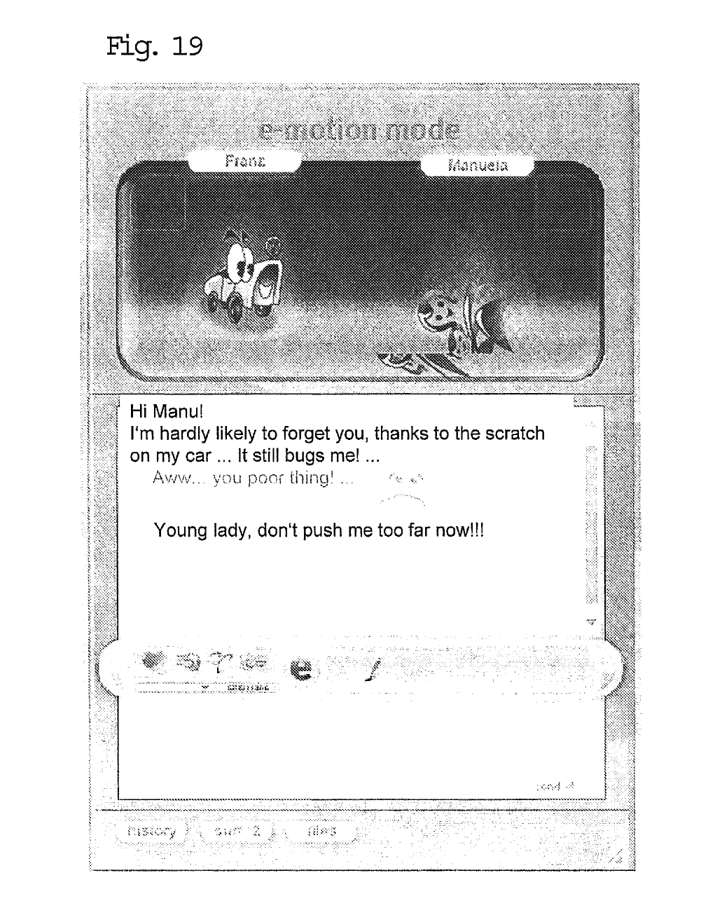

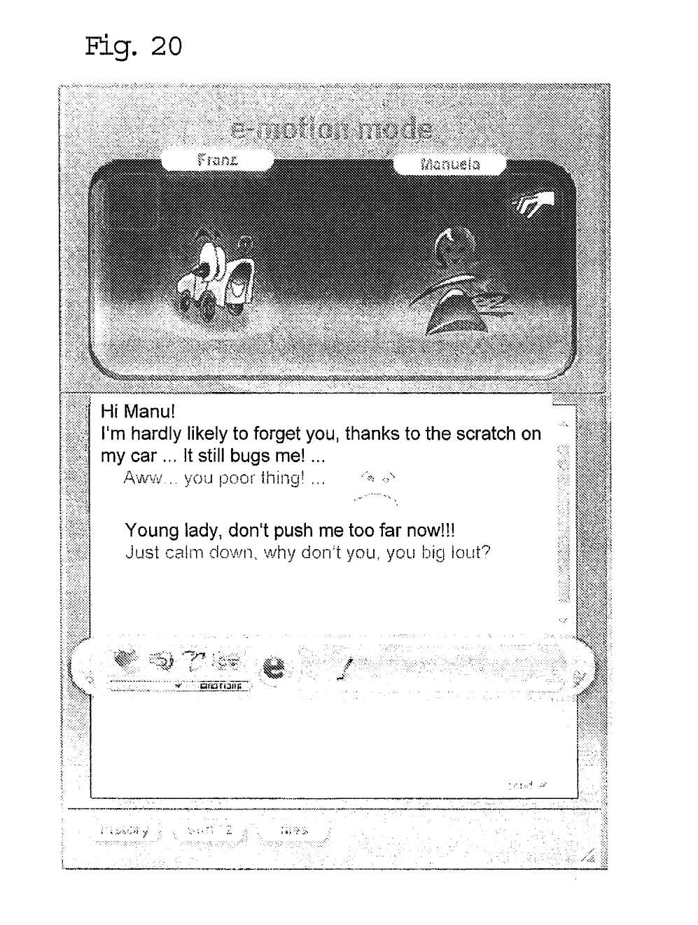

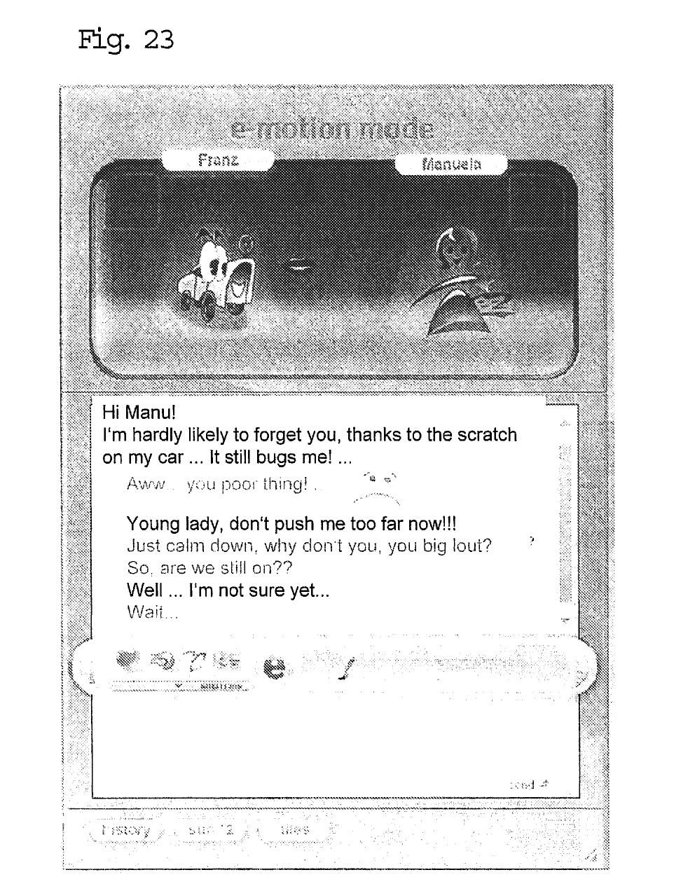

In response to Manuela's slightly mocking drawing 19, Franz inputs a further text and moves his mouse cursor 41 onto the animation button 43, which presents a “boxing glove” (see FIG. 16). By dragging & dropping, Franz moves the boxing glove 43 onto Manuela's representative (see FIG. 17), so that an interaction is triggered in which Franz's representative fires off a boxing glove at Manuela's representative (see FIG. 18). Manuela's representative is hit by this and falls over (see FIG. 19). Thereupon Manuela for her part triggers an interaction in which her representative places a thundercloud above Franz's representative (see FIGS. 20 to 22). In order to put this right again, Manuela then subsequently sends puckered lips to Franz's representative via her representative (see FIG. 23).

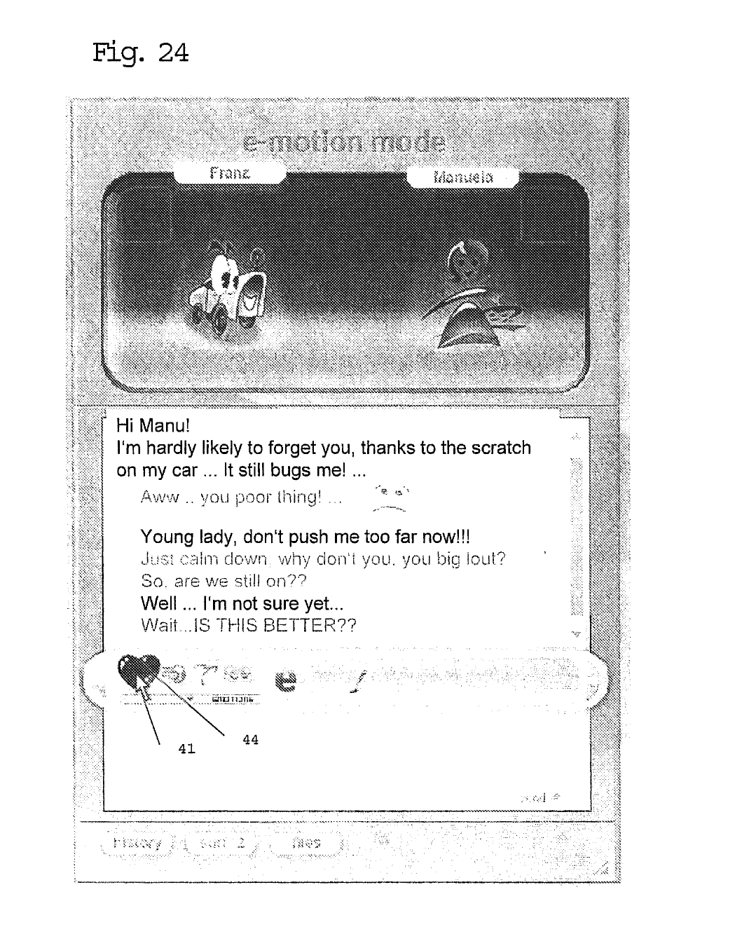

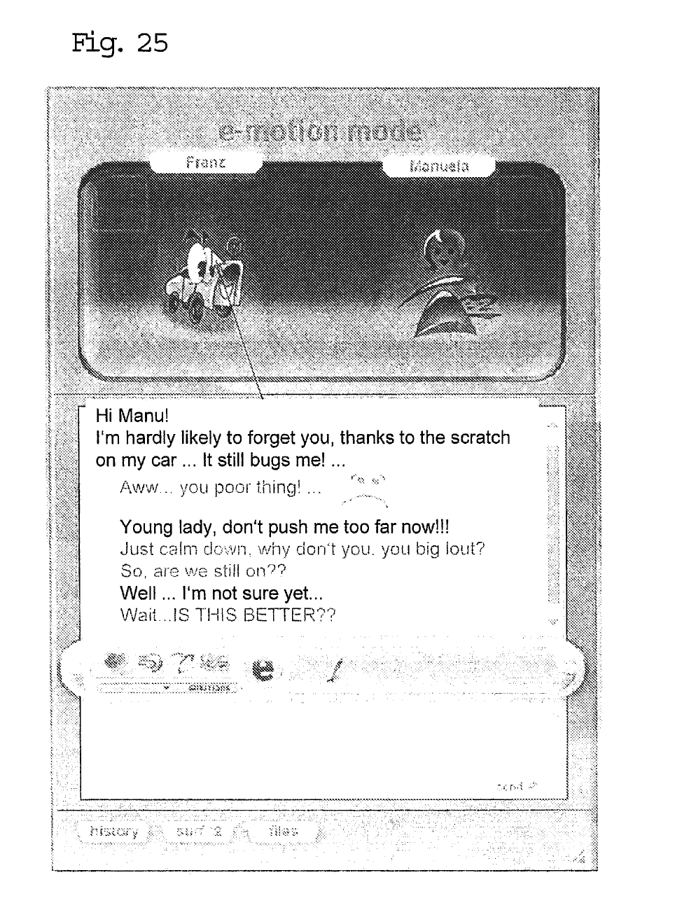

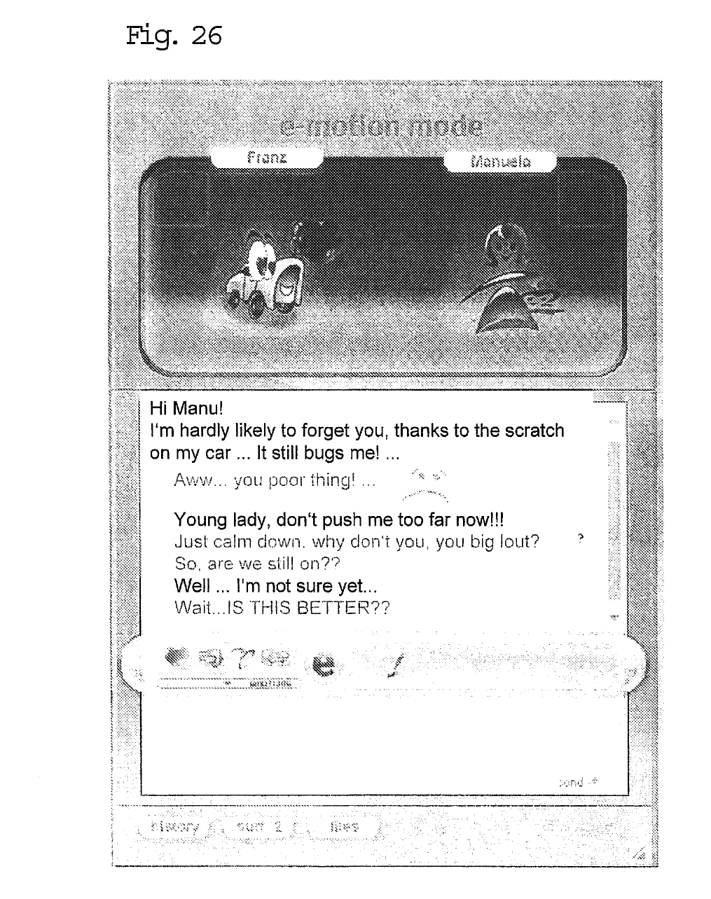

In order to express his good feelings about the puckered lips, Franz this time moves his mouse cursor 41 onto the heart 44 (see FIG. 24) and drags this onto his representative (see FIG. 25). An animation is thereby triggered in which Franz's representative sends out little hearts (see FIG. 26).

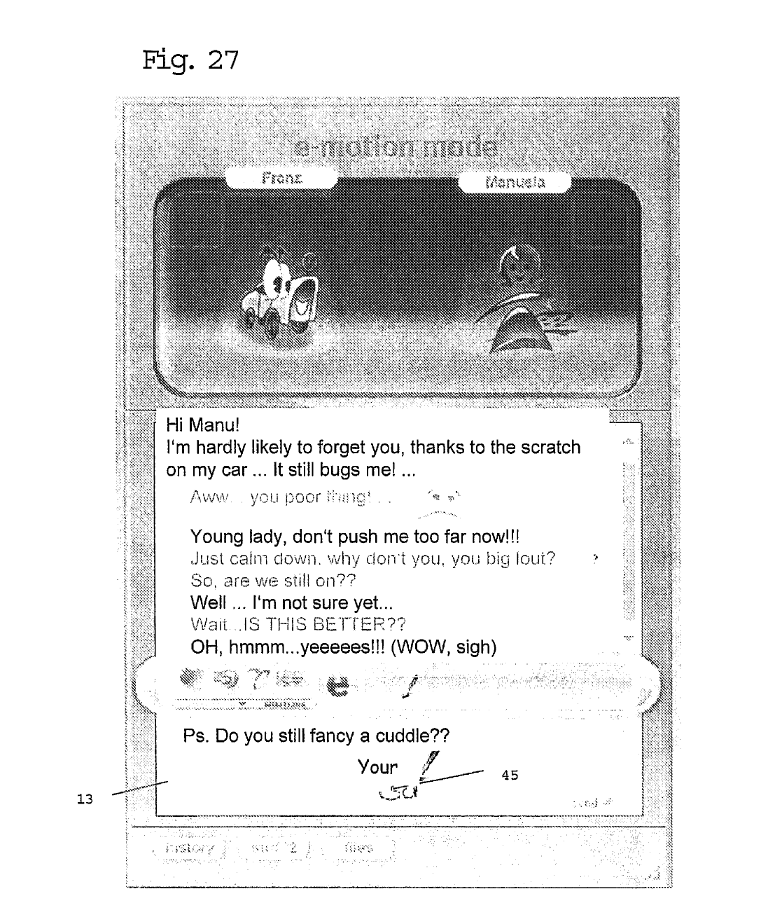

Finally, Franz prepares yet another text message in his draft section 13. He embellishes this with a closing greeting 45 drawn free-hand by means of the drawing function (see FIG. 27). To send the text message, Franz clicks on the send button 14 with his mouse cursor 41 (see FIG. 28). After dispatch the message is presented in both Franz's and Manuela's respective messages sections.

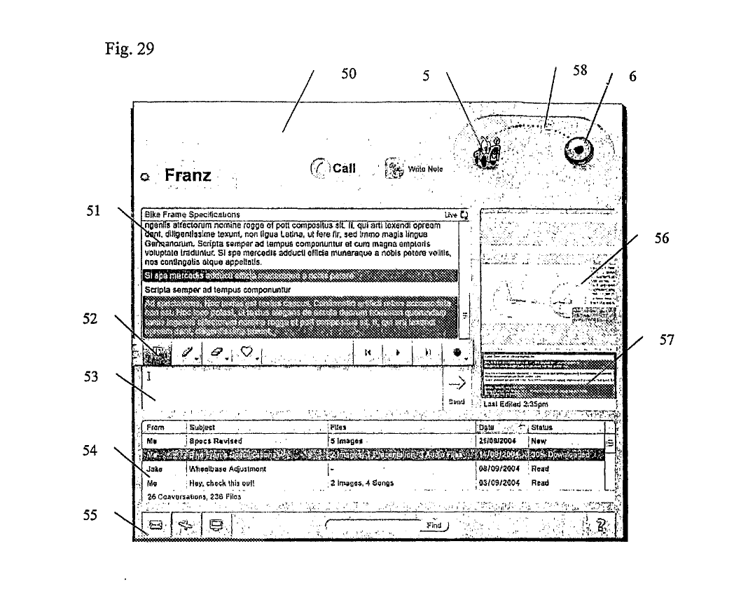

Another user interface 50 is presented in FIG. 29. This has an alternative layout with the following areas:

Firstly, there is a communications area 51 which contains a messages section and via which the current communication takes place in real time or near-real time, and there is a preparation area 53 with a drafting section in which the respective user can prepare his intended contributions (text, graphics, emotions etc.), before sending them to the other user by pressing the send button. A slider 52 with control bar is also provided which separates the areas 51 and 53 from one another and provides control elements for text input, for drawing etc. Thus the structure of this interface 50 essentially also corresponds to the interface already presented in FIG. 1.

Here in FIG. 29 an overview area 55 with history is now also provided in which all previous communications are listed. Listing can be chronological, thematic or user-related. Also located at the bottom end is an area 55 with a menu bar which contains various function buttons comparable with the menu bar presented in FIG. 1.

The layout shown in FIG. 29 also has yet another navigation area 56 which serves for navigation within a single (still ongoing or already completed) communication. For this there is i.a. a movable window with segment 51 which includes a sub-area in the navigation area, wherein this sub-area is then presented enlarged in the area 51. This is thus an enlargement or magnifying function. During an ongoing communication the segment 57 always tracks the area 51 in real time. Through this “tracking” the user always has the overview and orientation within the communication. By moving the segment 57 he can jump at any time to any points which are then displayed enlarged in the area 51, so that the user if appropriate can supplement the communication precisely at this point. Thus an interleaved supplementing and where appropriate modification of a communication is made possible.

The user interface 50 also has another separate area in which the representatives 5 and 6 (combots) of the two users (here “Franz”'s car and “Vroni's” eye) are presented in interaction. In this case, however, not only the non-verbal communication is presented by emotions, as has already been described before (FIGS. 1-29). Here, the remainder of the communication which takes place between the two users is also now displayed, such as e.g. transfer of files (file transfer) or text (by e-mail, SMS), instant messaging or chat as well as telephone conversations (VoIP, PSTN) etc. For this an appropriate symbol 58 is animated and presented, such as e.g. a document flying from combot 5 to combot 6 which indicates a file transfer. Thus the users obtain total overview of all types of communication taking place between them.

Two or more users can communicate with one another in a particularly attractive, versatile and varied way with the just-described communications method and system. In particular through the use of virtual representatives and their animation or interaction, moods, feelings and emotions can be exchanged in a particularly effective and clear way between the users.

A very convenient non-verbal communication can be carried out with the described invention, in particular through the user-friendly operation by mouse clicks and dragging & dropping. The described representatives (combots) and the presentation of the transfer of emotions that takes place between them makes a very neat impression on the users and thus a very clear and direct transfer of the respective emotion, which can even reproduce gestures, body language and facial expressions. The interaction between the combots, in particular the predeterminable and automatically controllable interaction, offers the communications partners involved a novel form of communication, wherein the actual levels of the communication of content combines with a playful level. The personal idiosyncracies and preferences of the users are taken into account by system-supported recording and assessment of user-specific data, and increase the convenience and acceptance of the communication according to the invention.

1-17. (canceled)

18. Method of telecommunication between a first user and a second user over a telecommunications network, the method comprising:
providing a first connection between the first user and a telecommunications network via a first terminal;
providing a second connection between the second user and the telecommunications network via a second terminal;
allocating a first virtual representative to the first user and a second virtual representative to the second user;
presenting the first and second virtual representatives on the first terminal and on the second terminal;
transferring information from the first user to the second user and vice versa by an animation of at least one of the first and second representatives and by an interaction between the first and second representatives, wherein at least one of the animation and the interaction takes place in response to a drag & drop command of a user, and wherein an animation of the first virtual representative takes place in response to a command of the first user and an animation of the second virtual representative takes place in response to a command of the second user.

19. The method as recited in claim 18, wherein the animation and/or interaction is presented simultaneously, parallel and in real time on the first and second terminals.

20. The method as recited in claim 18, further comprising at least one of:
directly interrupting an ongoing animation or interaction in response to a new user command to carry out a desired animation or interaction;
concluding an ongoing animation or interaction and presenting a desired animation or interaction in response to a user command to carry out the desired animation or interaction;
placing a desired animation or interaction in a waiting list of respective animations or interactions to be carried out in response to a user command to carry out the desired animation or interaction; and
interrupting a first animation or interaction triggered by the first user and replacement of the first animation or interaction by a second animation or interaction triggered by the second user and vice versa.

21. The method as recited in claim 18, further comprising:
recognizing at least one of a speech and a text input by the first or second user into the respective one of the first and second terminals;
analyzing and interpreting the speech or text input;

22. The method as recited in claim 21, further comprising:
performing a video recognition of at least one of the first and second user's facial expression; and
analyzing and interpreting the facial expression.

23. The method as recited in claim 22, further comprising:
providing a plurality of suitable animation or interaction possibilities in tune with a sense of at least one of the speech input, the text input and the facial expression.

24. The method as recited in claim 23, further comprising:
animating at least one of the first representative, the second representative and an interaction between the first and second representatives in tune with a sense of at least one of the speech input, the text input and the facial expression.

25. The method as recited in claim 18, further comprising:
presenting animation and interaction possibilities of the first and second representatives in a tabular overview, wherein the tabular overview has a fixed number of classes in which the animation and interaction possibilities are collected and can be retrieved.

26. The method as recited in claim 18, further comprising
providing a drawing function so as to enable a real-time transfer of a drawing by at least one of the first and second users on a respective one of the first and second terminals to the other one of the first and second users on the other one of the first and second terminals.

27. The method as recited in claim 18, further comprising:
presenting a mood display on a respective one of the first and second terminals indicating a current respective mood of one of the first and second representatives;

28. The method as recited in claim 27, further comprising animating the representative as a reaction to a modification of the mood display.

29. The method as recited in claim 18, wherein the presentation of the first and second representatives at the first terminal is one of a mirror image and an inverted mirror image of the presentation of the first and second representative at the second terminal.

30. The method as recited in claim 29, wherein at least one of the animation of the first or second representative and the interaction between the first and second representatives takes place depending on predeterminable criteria.

31. The method as recited in claim 30, wherein the criteria are stored in a user profile allocated to at least one of the first and second users.

32. The method as recited in claim 18, further comprising providing a selection of animations and/or interactions to be transferred to at least one of the first and second two users.

33. The method as recited in claim 32, further comprising proposing the selection to be transferred to predeterminable criteria stored in a user profile allocated to at least one of the first and second users.

34. The method as recited in claim 33, the predeterminable criteria include details about at least one of the first and second users.

35. The method as recited in claim 34, wherein the details include information relating to at least one of a gender, age, nationality, mother tongue, speech habit, speech pattern, place of residence, interest and hobby.

36. The method as recited in claim 18, wherein the drag & drop command relates to the at least one of the first and second representative, and wherein the animation or interaction takes place depending on which of the two representatives the drag & drop command relates to.

37. The method as recited in claim 22, wherein the recognition of the speech or text input or the video recognition takes place according to predeterminable criteria stored in a user profile allocated to at least one of the first and second users.

38. The method as recited in claim 37, wherein the predeterminable criteria comprise details about at least one of the first and second users.

39. The method as recited in claim 38, wherein the details include information relating to at least one of a gender, age, nationality, mother tongue, speech habit, speech pattern, place of residence, interest and hobby.

40. The method as recited in claim 27, wherein the and/or the interaction depends on the mood display, wherein the mood display displays a current prevailing emotional mood of at least one of the first and second users.

41. The method as recited in claim 27, wherein the mood display for at least one of the first and second users displays a respective current prevailing emotional mood, and wherein further comprising modifying the mood display according to a transferred emotion and/or interaction.

42. The method as recited in claim 32, wherein the selection is provided according to a mood display which, for at least one of the first and second users, displays a current prevailing emotional mood of the respective user.

43. The method as recited in claim 32, wherein the selection is provided in a form of assembled groups and/or classes, at least one of the assembly of the classes and the selection of the animations and/or interactions is automatic and pseudo-randomly controlled.

44. A system of carrying out the method as recited in claim 18.
